(19) United States
(12) Patent Application Publication
(10) Pub. No.: US 2025/0141287 A1
(43) Pub. Date: May 1, 2025

(54) ROTOR LAMINATION FOR AN ELECTRIC MACHINE, ELECTRIC MACHINE, VEHICLE AND METHOD FOR PRODUCING ROTOR LAMINATIONS

(71) Applicant: Ford Global Technologies, LLC, Dearborn, MI (US)

(72) Inventors: Raphael Koch, Odenthal (DE); Viktor Haeuser, Burscheid (DE); Wenbo Liu, Ann Arbor, MI (US)

(21) Appl. No.: 18/927,246

(22) Filed: Oct. 25, 2024

(30) Foreign Application Priority Data
Oct. 27, 2023 (DE) 102023129770.8

(51) Int. Cl. H02K 1/276; B60K 1/00; B60K 7/00; H02K 15/03

(52) U.S. Cl. CPC H02K 1/276; B60K 1/00; B60K 7/0007; H02K 15/03

(57) ABSTRACT

The present disclosure relates to rotor laminations having a first region and a second region, wherein the first region is larger than the second region and a first alloy is present in the first region and a second alloy is present in the second region. In accordance with the disclosure, the second alloy is soft-magnetic and has a higher magnetic permeability than the first alloy. The present disclosure further relates to an electric machine and an electrically powered vehicle. In addition, a method for producing the aforementioned rotor laminations is disclosed. For this purpose, a corresponding green part is printed in a stencil printing process and then sintered to form the rotor lamination.

### CROSS REFERENCE TO RELATED APPLICATION

The present application claims priority to German Patent Application No. 102023129770.8 filed on Oct. 27, 2023. The entire contents of the above-listed application is hereby incorporated by reference for all purposes.

### TECHNICAL FIELD

The present disclosure relates to a rotor for an electric machine, such an electric machine and a method for producing electric machines. Further disclosed is an electrically powered vehicle.

### BACKGROUND AND SUMMARY

The performance or power density of electric machines and their efficiency play a major role, particularly—but not only—in electromobility. Various approaches exist to optimize these parameters.

For example, the torque and efficiency of electric machines can be increased by reducing the lamination thickness or by selecting high-performance alloys. However, these soft-magnetic high-performance alloys are often extremely difficult to machine. The resulting production resources are correspondingly high.

Various solutions can be found in the prior art. The following are discussed as examples.

US 2021/0111613 A1 deals with the topic of changing the insulation density of electrical-steel laminations for electric motors. The main effect is to minimize eddy currents and thus increase efficiency.

US 2018/0233997 A1 relates to additively manufactured iron cores for electric motors with increased efficiency through the introduction of air gaps between the layers and within the layers. The main purpose is to reduce iron losses.

U.S. Pat. No. 11,362,552 B2 teaches the use of differently shaped laminations that are stamped and stacked. Some layers are produced in 3D form. In certain areas, non-ferromagnetic material is used to reduce leakage flux.

U.S. Pat. No. 11,025,142 B2 discloses a method in which stamped metal sheets are combined with additional reinforcements made of powder that is melted with a laser. The aim is to reduce the flux leakage and increase the structural strength of the rotor. There is a need to eliminate or at least reduce the disadvantages of the known systems without having to compromise to the extent that has been necessary up to now. In particular, there is still a need to optimize electric machines in terms of performance/power density and efficiency.

The issues described above are at least partially solved by the present disclosure. Individual aspects are explained with regard to devices, others with regard to a method. However, the aspects are to be transferred reciprocally accordingly.

According to one aspect, a rotor lamination is provided. The rotor lamination has a first region and a second region. The first region is larger than the second region. In addition, the rotor lamination comprises a first alloy in the first region and a second alloy in the second region. The second alloy is soft-magnetic and has a higher magnetic permeability than the first alloy.

Soft-magnetic materials are materials that can be easily demagnetized or remagnetized in a magnetic field. Soft-magnetic alloys in the context of this disclosure are alloys with a coercive field strength of less than 1000 A/m.

Soft-magnetic high-performance alloys, which have an even lower coercive field strength of less than 100 A/m, may be used in the second region of the rotor lamination. Examples of these include certain cobalt-iron alloys (FeCo) or silicon-iron alloys (FeSi) with a comparatively high silicon content of approximately 0.5 to 8 percent by weight.

The use of soft-magnetic alloys with increased permeability enables a higher magnetic flux and therefore a higher torque on the rotor. In addition, the magnetic flux is guided by the powerful soft-magnetic material on the deliberately formed flux paths.

According to an aspect, the first alloy is also soft-magnetic. Alternatively, it can also be a non-magnetic iron-based alloy. The subsequent magnetic flux in the rotor can be specifically guided by the choice of materials and the arrangement of the first region and the second region. Areas with non-magnetic iron-based alloys can be used in particular for mechanical strengthening of the rotor core.

This means that the combination of soft-magnetic high-performance alloys with conventional soft-magnetic or non-magnetic alloys makes targeted use of the material properties where they have a particularly positive influence on the efficiency and performance of the electric machine. In this way, the material use of resource-intensive alloys can be significantly reduced.

The rotor lamination can have a number of cut-outs. At least some of these cut-outs then form pockets in the later rotor stack to accommodate permanent magnets. The use of these rotor laminations is particularly advantageous in reluctance torque-assisted permanent magnet machines, in which the permanent magnet component can be reduced in this way.

At least parts of the region with the higher permeability can be advantageously located between the magnet pockets and an outer circumference of the rotor lamination.

The magnet pockets can, for example, be arranged in pairs in each case in a V-shape so that they define a magnetic island between them. The region with the higher permeability (the second region) optionally comprises large parts of these magnetic islands.

Optionally, the rotor laminations are designed in such a way that each of two pairs of magnet pockets are arranged in a V-shape, one above the other in a radial direction, forming a double V-shape. The second region containing the more permeable alloy then may comprise a region between the magnet pockets arranged one above the other.

The magnet pockets can also have lateral free regions as magnetic flux barriers. The lateral free region may be an area adjacent to the pockets or within the pockets that are left free of any magnetic material. The lateral free region may be an air gap on each side of a magnet positioned within the magnet pocket. The first region, with the lower permeability, optionally also extends around these magnetic flux barriers.

The configurations described above have proven to be particularly suitable for the intended application.

Further provided is an electric machine with a rotor made of rotor laminations as described above.

These electric machines are preferably reluctance torque-assisted permanent magnet machines. These electric machines are particularly efficient with reasonable material use and have very good speed-torque behavior.

According to a further aspect, a vehicle comprising an electric machine as described above is also provided.

In this context, a vehicle is understood to be a device that is configured for the transportation of objects, freight or people between different destinations. Examples of vehicles include land-based vehicles such as motor vehicles, electric vehicles, hybrid vehicles or the like, rail vehicles, aircraft or watercraft. Preferably, vehicles in the present context may be considered as road-based vehicles, such as cars, trucks, buses or the like.

In some embodiments, the electric machine described above can be arranged in the vehicle as a front-wheel drive, center drive, underfloor drive or wheel hub drive, for example. Also disclosed is a method for producing the rotor laminations described above. The method has the following method steps:
S1: creating a rotor lamination green part using a stencil printing process and
S2: sintering the rotor lamination green part to form a rotor lamination.

The creation of the rotor lamination green part in turn comprises the following sub-method steps:
S1a: applying a first suspension in a first region of the rotor lamination green part defined by a first mask and
S1b: applying a second suspension in a second region of the rotor lamination green part defined by a second mask.

Either the first suspension or the second suspension could be applied first.

A suspension is a heterogeneous substance mixture of a liquid and finely dispersed solids (particles), in this case a metal powder.

The suspensions may be pastes. A paste is a suspension with a high solids content. Pastes are no longer free-flowing, but spreadable. By using pastes, flowing of the edges after printing and “blurring” of the component may be reduced.

Pastes that exhibit shear-thinning behavior may be used. The viscosity of these pastes decreases at a high shear rate (e.g. on contact with the squeegee). However, if there is no shear, e.g. after the printing process, the viscosity is very high.

As already described, the first region is larger than the second region when creating the rotor lamination green part. The first suspension contains a powder of a first alloy and the second suspension contains a powder of a second alloy. In accordance with the disclosure, the second alloy is soft-magnetic and also has a higher magnetic permeability than the first alloy.

The printing process can be used to produce particularly thin electrical-steel laminations with a thickness of less than 0.4 mm, optionally less than 0.3 mm and optionally less than 0.25 mm. The thinner the electrical-steel lamination, the lower the eddy current losses occurring at high frequencies and the higher the efficiency of the electric machine. However, this does not apply indefinitely. As the insulation layer between the electrical-steel laminations becomes thicker, the stacking factor decreases with increasingly thinner laminations. The electrical-steel laminations should therefore have a minimum thickness of 0.05 mm, optionally at least 0.1 mm and optionally at least 0.15 mm.

Optionally, the first alloy and the second alloy can have coefficients of thermal expansion that differ by no more than 20%. For example, the coefficients of thermal expansion of both alloys are optionally in the range of 8-14 ppm/K or optionally in the range of 10-12 ppm/K.

Additionally or alternatively, the first alloy and the second alloy may have moduli of elasticity that differ by no more than 20%. The moduli of elasticity of both alloys may, for example, be in the range of 160-200 GPa, optionally in the range of 170-190 GPa.

Optionally, the sinter shrinkage of the rotor lamination green part in the first region does not deviate by more than 20% from the sinter shrinkage in the second region.

Optionally, the sintering temperatures of the first alloy and the second alloy do not differ by more than 250K. For example, the sintering temperatures can be in the range of 1200-1500° C., optionally in the range of 1300-1400° C.

The disclosed method minimizes the reject rate and thus affects the efficient use of resources.

All of the features described with regard to the various aspects can be combined individually or in (sub-) combinations with other aspects.

The disclosure and other advantageous embodiments and developments thereof are described and explained in greater detail below with reference to the examples shown in the drawings, in which:

### BRIEF DESCRIPTION OF THE FIGURES

FIG. 1 shows a simplified schematic representation of a rotor lamination and a detail thereof,

FIG. 2 shows a simplified schematic representation of a method for producing rotor laminations,

FIG. 3 shows a simplified schematic representation of an electric machine, and

FIG. 4 shows a simplified schematic representation of a vehicle.

FIG. 5 shows a simplified schematic representation of a rotor lamination.

### DETAILED DESCRIPTION

The following detailed description in conjunction with the accompanying drawings, in which like numerals refer to like elements, is intended as a description of various embodiments of the disclosed subject matter and is not intended to represent only the individual embodiments. Any embodiment described in this disclosure is by way of example or illustration only and should not be construed as preferential or advantageous over other embodiments. The illustrative examples contained herein are not intended to be exhaustive and do not limit the claimed subject matter to the precise forms disclosed. Various modifications of the described embodiments will be readily apparent to those skilled in the art, and the general principles defined herein may be applied to other embodiments and applications without departing from the spirit and scope of the described embodiments. Therefore, the described embodiments are not limited to the embodiments shown, but have the widest possible scope of application consistent with the principles and features disclosed herein.

All features disclosed below with respect to the exemplary embodiments and/or the accompanying figures may be combined alone or in any sub-combination with features of aspects of the present disclosure, including features of preferred embodiments, provided that the resulting combination of features is expedient to a person skilled in the art.

For the purposes of the present disclosure, the phrase “at least one of A, B and C” means, for example, (A), (B), (C), (A and B), (A and C), (B and C) or (A, B and C), including all other possible combinations when more than three elements are listed. In other words, the term “at least one of A and B” generally means “A and/or B”, namely “A” alone, “B” alone or “A and B”.

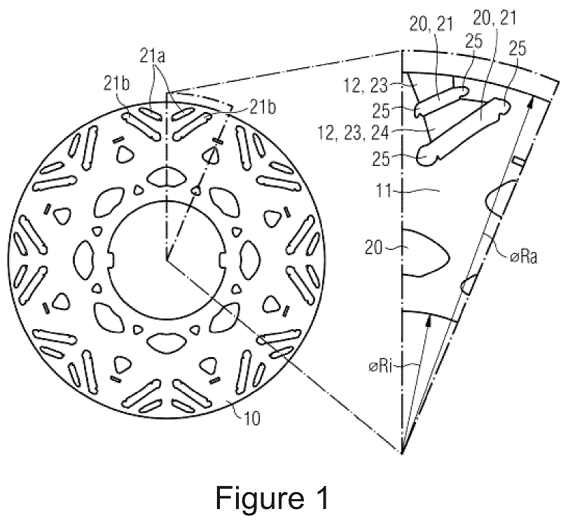

FIG. 1 shows a simplified plan view of a rotor lamination 10 and an enlarged detail to the right of it.

The rotor lamination 10 is intended for an electric machine that combines the functionality of a permanently excited synchronous machine with an additional reluctance torque caused by the buried magnets due to the arrangement of the magnets within the rotor. In principle, however, the technical teaching imparted can also be used for pure reluctance synchronous machines or pure permanently excited synchronous machines.

The rotor lamination is substantially circular and flat and has a plurality of cut-outs 20. Depending on their position and location, these have different functions.

Some of the cut-outs 20 are intended as pockets 21 for holding permanent magnets. They generally have an elongated shape, but can also be shaped differently. The magnets, which may be rectangular, are held in a defined position by corresponding projections. A magnetic force applied by the stator's coil system is thus transferred to the rotor and generates the resulting torque.

Other cut-outs 20 are used either to direct the magnetic flux in predetermined paths or to cool the rotor, for example via coolant channels. Further cut-outs can be provided to reduce the rotor weight.

The cut-outs 20 that form pockets 21 for holding the magnets also have lateral free regions as magnetic flux barriers 25. Lateral free regions 25 may be areas adjacent to the pockets 21 or within the pockets 21 that are left free of any magnetic material. The lateral free regions 25 may be air gaps on each side of a permanent magnet in the pocket 21.

The magnet pockets 21 may be arranged in pairs in a V-shape and together form a pole of the synchronous machine. In the variant shown, in each case two pairs of magnet pockets 21a, 21b are arranged one above the other in a radial direction. This arrangement is also known as a “double V” configuration for electric machines with buried permanent magnets.

Further triangular or triangle-shaped free regions are formed between the poles and also act as flux barriers.

Other configurations to which the considerations made here can be readily transferred are arrangements with a single pair of magnet pockets arranged in a V-shape (“single-V”) or the so-called “delta” configuration, in which a third magnet pocket is located (radially) above the pair of magnet pockets arranged in a V-shape.

In order to address the efficiency and/or torque of an electric machine and in particular the range of an electrically powered vehicle, a particularly advantageous hybrid electrical-steel lamination layout for rotors is proposed.

Manufacturing the entire rotor core from the relatively-expensive high-performance soft-magnetic alloys may be resource-prohibitive. Instead, the high-performance soft-magnetic alloys may be strategically combined with soft-magnetic materials with a lower magnetic permeability or a non-magnetic iron-based alloy. In this way, the high-performance soft-magnetic alloys are used only in targeted areas in which it is determined that the rotor lamination would benefit most from the high-performance alloy. Selective use of the high-performance alloy may reduce the overall resources while still providing good performance.

Therefore, a layout is proposed that identifies specific regions that benefit most from the high-performance material and regions where the benefits are negligible.

In other words, the rotor lamination 10 has a first alloy in a first region 11 and a second alloy in a second region 12. At least the second alloy is soft-magnetic and has a higher magnetic permeability than the first alloy. The first alloy can preferably also be soft-magnetic or alternatively can be a non-magnetic iron-based alloy.

The first region 11 is larger than the second region 12. For example, the second region 12 may have only a small area proportion in relation to the first region 11. For example, the second region can make up a maximum of 25%, optionally a maximum of 20% or even only 15% or less than 10% of the total area of the rotor lamination 10 (without cut-outs).

In addition to the first and second regions 11, 12, it may be useful to provide further regions with different material properties. For example, the first and second regions 11, 12 could be soft-magnetic as described above, while the rotor lamination 10 also has a non-magnetic iron-based alloy in defined regions.

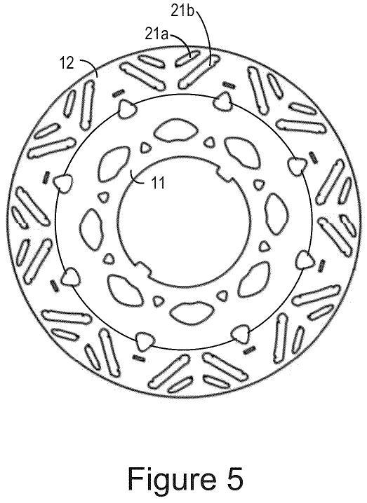

At least parts of the second region 12 lie between the magnet pockets 21 and an outer circumference Ra of the rotor lamination 10. Optionally, the entire second region 12 can be arranged in a circular ring, which is defined radially outwardly by the outer circumference Ra and inwardly substantially by the position of the pockets 21, as shown in FIG. 5. For example, the circular ring may be defined radially inwardly by an innermost portion of the pockets 21.

The V-shaped pockets 21 define a so-called magnetic island between the magnets forming opposing sides of the V-shape. The second region 12 comprises at least large parts of the magnetic islands. A web between the magnet pockets 21 can comprise the first alloy.

In particular, as depicted in FIG. 1, the second region 12 may comprise a region 24 between the pairs of pockets 21a, 21b arranged one above the other in a double-V configuration. Additionally or alternatively, the second region 12 may comprise a region 23 extending from the magnet pocket 21a, located radially outward from magnet pocket 21b, to the outer circumference Ra of the rotor lamination 10. The second region 12 may not extend beyond the magnets to the magnetic flux barriers 25. In one example, the second region 12 may only span a region 24 bounded between the ends of a magnet positioned in pocket 21b and the ends of a corresponding magnet positioned in pocket 21a radially outward from pocket 21b, and a region 23 bounded by outer edges of a magnet positioned in pocket 21a and an outer circumference Ra of the rotor lamination 10, for each side of each double-V shape. The first region 11 may cover the remaining surface of the rotor lamination.

Around the magnetic flux barriers 25 of the pockets 21 extends the first region 11 or a third region, which specifically comprises a non-magnetic iron-based alloy.

Since the rotor laminations 10 described cannot be produced using conventional forming and punching methods, a new production method is proposed.

As an alternative to production methods such as the joining (e.g. laser welding) of separately produced sheet metal parts, which would, however, entail high material handling resources in particular, or generative layering processes such as selective laser sintering, which would, however, generally be uneconomical in large-scale production, a production method is proposed in which a corresponding green part is first printed from suitable pastes using stencil printing and then sintered to form the rotor lamination.

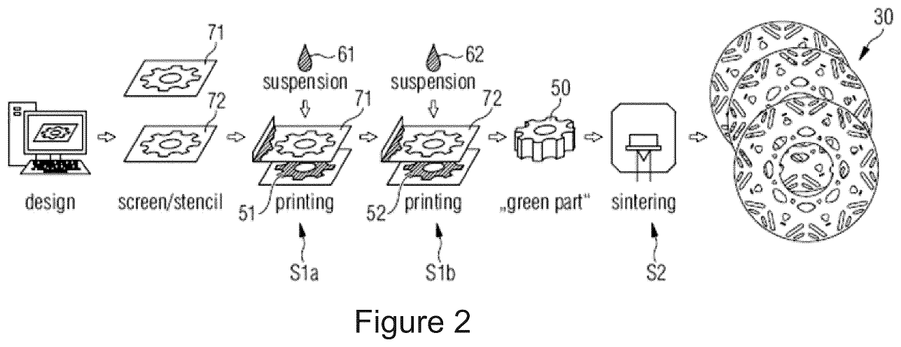

Such a method is simplified and shown in a sketched representation in FIG. 2. It comprises the following steps:

First, in a first method step S1, a rotor lamination green part 50 is produced using a stencil printing process, for example screen printing.

In the production of sintered workpieces, a green part or green body is an unsintered blank that can still be easily machined. For example, it is a powder bonded with binders. A green body is dimensioned in such a way that the end product obtains the planned size through shrinkage during sintering.

The production of the green part comprises (in a suitable sequence) the application Sla of a first suspension 61 in a first region 51 of the rotor lamination green part 50 defined by a first mask 71 and the application of a second suspension 62 in a second region 52 of the rotor lamination green part 50 defined by a second mask 72. Optionally, the suspensions 61, 62 may be pastes.

The applied suspensions should dry before the next processing step follows. Drying can be assisted by infrared emitters, for example, and takes around 1-25 seconds, depending on the layer thickness.

The first suspension 61 contains a powder of a first alloy and the second suspension 62 contains a powder of a second alloy.

The second alloy is soft-magnetic and has a higher magnetic permeability than the first alloy.

Although the shape of the green part 50 already corresponds to the later rotor lamination 10, the metal powder is only bound by a suitable binder as a matrix. The dimensions also still differ from the end product. Nevertheless, the first region 51 of the green part 50 is already larger than the second region 52.

In a second method step S2, the rotor lamination green part 50 is then sintered to form a rotor lamination 30.

Optionally, the first alloy and the second alloy have coefficients of thermal expansion that do not differ by more than 20%, reducing cracking or corrugating of the rotor lamination 30 during sintering. In particular, the coefficients of thermal expansion of the first alloy and the second alloy are in the range of 8-14 ppm/K, optionally in the range of 10-12 ppm/K.

The first alloy and the second alloy should also have moduli of elasticity that do not differ by more than 20%. In some examples, suitable materials have moduli of elasticity of each of the first alloy and the second alloy in the range of 160-200 GPa, optionally in the range of 170-190 GPa.

In order to minimize unevenness, the sinter shrinkage of the rotor lamination green part 50 in the first region should not deviate by more than 20% from the sinter shrinkage in the second region. The printing pastes with the alloys must be selected accordingly.

The sintering temperatures of the first alloy and the second alloy should also not differ by more than 250K. For example, the sintering temperatures can be in the range of 1200-1500° C., optionally in the range of 1300-1400° C.

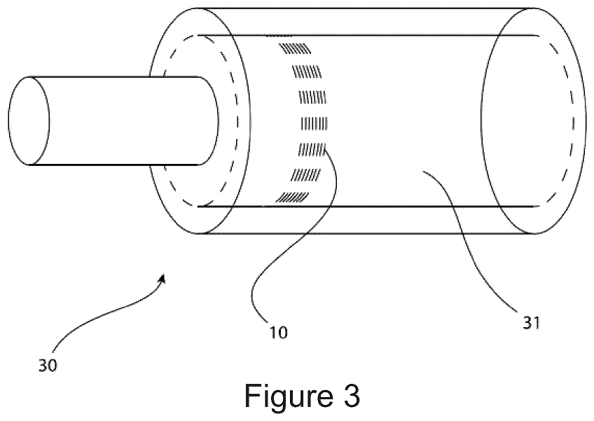

In FIG. 3, an electric machine 30 is shown in a simplified perspective view. The electric machine 30 comprises a rotor 31 which has a plurality of rotor laminations 10 as already shown and described. The electric machine is a reluctance synchronous machine with buried magnets. These types of electric machines are also known by the abbreviations IPM/IPSM (“Interior Permanent Magnet” or “Interior Permanent Magnet Synchronous Machine”, i.e. permanent magnet machines with integrated magnets), PMa-SynRM (“Permanent Magnet Assisted Synchronous Reluctance Motor”) or IPM-SynRM (“Internal Permanent Magnet Synchronous Reluctance Motor”, i.e. synchronous reluctance motor with buried permanent magnets).

This combination is particularly suitable for electrically powered vehicles because it combines desirable properties, namely high efficiency at low and high speeds. In addition, the proportion of permanent magnets can be significantly reduced in this way.

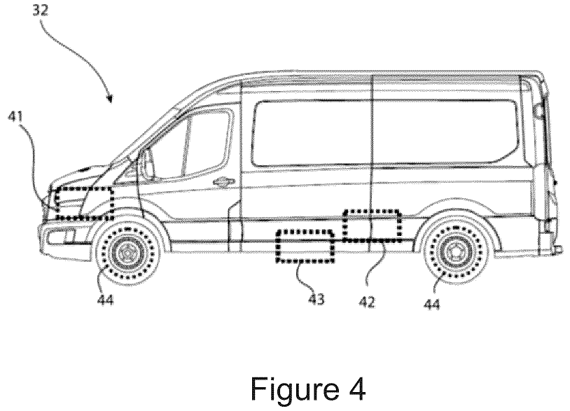

FIG. 4 shows a simplified, schematic representation of a vehicle 32 in a side view. The vehicle 32 has at least one electric machine as described above. The electric machine can, for example, be arranged in the vehicle 32 as a front-wheel drive 41, center drive 42, underfloor drive 43 or wheel hub drive 44.

Reference may be made to quantities and numbers in the present application. Unless expressly stated, such quantities and numbers are not to be regarded as limiting, but as examples of the possible quantities or numbers in the context of the present application. In this context, the term “plurality” may also be used in the present application to refer to a quantity or number. In this context, the term “plurality” means any number greater than one, e.g., two, three, four, five, etc. The terms “about”, “approximately”, “near”, etc. mean plus or minus 5% of the stated value.

Although the disclosure has been presented and described with reference to one or more embodiments, a person skilled in the art will be able to make equivalent changes and modifications after reading and understanding this description and the accompanying drawings.

1. A rotor lamination, comprising a first region and a second region, wherein the first region is larger than the second region, wherein the rotor lamination comprises a first alloy in the first region and a second alloy in the second region, wherein at least the second alloy is soft-magnetic, and wherein the second alloy has a higher magnetic permeability than the first alloy.

2. The rotor lamination according to claim 1, wherein the rotor lamination has a plurality of cut-outs, wherein at least some of the cut-outs form pockets for receiving permanent magnets, and wherein at least parts of the second region lie between the pockets and an outer circumference of the rotor lamination.

3. The rotor lamination according to claim 2, wherein the pockets are arranged in pairs in each case in a V-shape, so that they define a magnetic island between them, and wherein the second region comprises large parts of the magnetic islands.

4. The rotor lamination according to claim 3, wherein the pockets are arranged in such a way that in each case two pairs of pockets are arranged in a V-shape and lying one above the other in the radial direction as a double V-shape, forming an outer V-shape and an inner V-shape, wherein the outer V-shape is positioned radially outward from the inner V-shape, further wherein the second region comprises a region between the pockets lying one above the other.

5. The rotor lamination according to claim 4, wherein the pockets have lateral free regions as magnetic flux barriers, and wherein the first region extends around the magnetic flux barriers.

6. An electric machine comprising a rotor with rotor laminations according to claim 1, wherein the electric machine is a reluctance torque-assisted permanent magnet machine.

7. A vehicle with at least one electric machine according to claim 6, wherein the electric machine is arranged as a front-wheel drive, center drive, underfloor drive and/or wheel hub drive in the vehicle.

8. A method for producing the rotor lamination according to claim 1, comprising the following steps:
S1: creating a rotor lamination green part in a stencil printing process, comprising
S1a: applying a first suspension in a first region of the rotor lamination green part defined by a first mask and
S1b: applying a second suspension in a second region of the rotor lamination green part defined by a second mask,
Wherein the first region is larger than the second region,
wherein the first suspension contains a powder of a first alloy and the second suspension contains a powder of a second alloy, and
wherein at least the second alloy is soft-magnetic and has a higher magnetic permeability than the first alloy,
S2: sintering the rotor lamination green part to form a rotor lamination.

9. The method according to claim 8, wherein the first alloy and the second alloy have coefficients of thermal expansion differing by not more than 20%, wherein the coefficients of thermal expansion of the first alloy and the second alloy are in the range of 8-14 ppm/K

10. The method according to claim 8, wherein the sinter shrinkage of the rotor lamination green part in the first region does not deviate by more than 20% from the sinter shrinkage in the second region.

11. The method according to claim 8, wherein the sintering temperatures of the first alloy and the second alloy do not differ by more than 250K, wherein the sintering temperatures of the first alloy and the second alloy are in the range of 1200-1500° C.

12. The method according to claim 8, wherein the first alloy and the second alloy have moduli of elasticity differing by not more than 20%, wherein the moduli of elasticity of the first alloy and the second alloy are in the range of 160-200 GPa.

13. The method according to claim 9, wherein the coefficients of thermal expansion are in the range of 10-12 ppm/K.

14. The method according to claim 12, wherein the moduli of elasticity of the first alloy and the second alloy are in the range of 170-190 GPa.

15. The method according to claim 11, wherein the sintering temperatures of the first alloy and the second alloy are in the range of 1300-1400° C.

16. The rotor lamination according to claim 1, wherein the second alloy is a soft-magnetic high-performance alloy with a coercive field strength of less than 100 A/m and the first alloy is a soft-magnetic alloy with a coercive field strength between 100 A/m and 1000 A/m.

17. The rotor lamination according to claim 16, wherein the second alloy is a cobalt-iron alloy or a silicon-iron alloy with a silicon content of 0.5 to 8 percent by weight.

18. The rotor lamination according to claim 5, wherein, for each side of the double V-shape, the second region comprises a first area bounded between ends of a magnet positioned in a pocket of the inner V-shape and corresponding ends of a corresponding magnet positioned in a pocket of the outer V-shape, and a second area bounded by outer edges of a magnet positioned in the pocket of the outer V-shape and the outer circumference of the rotor lamination, and wherein the first region comprises a remaining surface of the rotor lamination.

19. The rotor lamination according to claim 2, wherein the second region is arranged as a circular ring, the circular ring defined radially outwardly by the outer circumference and radially inwardly by an innermost portion of the pockets.
